(19) United States
(12) Patent Application Publication
(10) Pub. No.: US 2010/0308731 A1
(43) Pub. Date: Dec. 9, 2010

(54) Light Engine

(76) Inventor: Anthony Mo, Mountain Lakes, NJ (US)

Correspondence Address: Gearhart Law LLC, 41 River Road, Suite 1A, Summit, NJ, 07901, US

(21) Appl. No.: 12/455,510

(22) Filed: Jun. 3, 2009

(51) Int. Cl. H01J 61/52

(52) U.S. Cl. 315/112; 362/294

(57) ABSTRACT

The present invention discloses an integrated electronic light source module that has a base plate to support an electronic light source; a power supply to drive this light source; and a heat sink to dissipate the heat generated by this invention. The cooling fins of the heat sink are in perpendicular relation to the axis along which the natural flow of heat is oriented. Such a setup provides for effective heat dissipation and a more rapid cooling then disclosed in the prior art. Although, the present invention can be completely autonomous, an optional coupling unit can be included that is adapted to connect to an external power source, such as a socket of a light fixture. The electronic light source embodies the use of an LED element, or of a more traditional fluorescent lighting. The present invention increases modularity of the device by integrating all components needed for an effective prolonged illumination into a single swapable module.

### FIELD OF THE INVENTION

The invention relates to a modular device capable of efficient light generation, more particularly to a functionally autonomous, integrated light source unit.

### BACKGROUND OF THE INVENTION

The invention relates to a self-contained electronic device capable of producing light. One of common implementations of the present invention is in light fixtures and in other articles of manufacture intended to produce light. Light producing devices tend to go out of order due to constant application and use of cost-saving manufacturing measures. Therefore, it is highly desirable to have a practical device that is highly durable but not expensive to produce, and at the same time, easily and cheaply replaced. An additional desirable feature of the present invention is the ability to easily manufacture a device out of recycled materials and components

An electronic device must have several enabling components. There must be some means of delivering power to the devices in the form of electrical current. There must also be means of dissipating heat that gets generated as electric current flows through the device. Finally there must be a means of achieving the purpose of the device, which in the present invention is a means to create light. The present invention increases modularity of a representative device by integrating the three main enabling components into a single unit. This improved modularity further expands the broad continuum of uses that the present invention is compatible with.

Additionally, any electrical current generates electromagnetic interference or EMI, which is defined as unwanted electrical signals that produce undesirable effects in a control system, such as communication errors, degraded equipment performance and malfunctions. This type of noise is also undesirable because it may interfere and disrupt other activities, such as radio and television translation, phone service or other services or devices. There are also ongoing studies aimed at determining the detrimental effects of EMI emissions on human health. The present invention is more EMI conscious than devices known in the art, because it reduces the undesirable EMI noise by placing the power supply in close proximity to the current drawing light source, thereby reducing the amount of EMI emissions that manage to escape the circuit. This is especially important if the intended use will include close proximity with parts of the human body or in LED light arrays, such is personal electronic devices, or in LED based lighting. Where an LED array is utilized, EMI emissions are magnified in direct proportion to the size and capacity of such an array. An EMI conscious architecture embodied in the present invention is therefore highly desirable since it may help offset higher EMI output of other electronic equipment. Low EMI emissions are especially important at locations requiring an unusual need for accuracy and predictability of electronic equipment, such as in laboratories and on airplanes. Although light generating devices have been known for a long time, none offering the same benefits have been disclosed.

### DESCRIPTION OF THE RELATED ART

U.S. Patent Application No. 2008/0022399 discloses a modular LED lighting fixture, where the shape and brightness of light output from the fixture can be altered by changing LED modules and/or power supplies powering the modules within the fixture. The fixture can include a housing, a modular, removable LED module attached within the housing, and at least one modular, removable power supply attached to the housing for powering the LED module.

U.S. Pat. No. 7,513,651 shows a backlight module that includes a reflective plate, a light module and a heat dissipation module. The light module and the heat dissipation module are disposed at two sides of the reflective plate. The light module has a number of light emitting diodes to emit light. The heat dissipation module includes at least one heat pipe, a heat sink and a fan on an end of the heat sink. The heat pipes are disposed between the reflective plate and the heat sink to transfer the heat generated by the light module. The at least one heat pipe defines a number of nano-scale recesses in an inner surface thereof.

U.S. Pat. No. 7,344,296 teaches a socket fixed to a heat sink holds a card-type LED module formed by integrating LED elements. The socket (6) includes: a frame structure for holding the LED module (1000) with its light source unit exposed through the frame opening; and a pressing member positioned around the opening for pressing the back surface of the LED module against the heat sink (2122). The socket may include a structure including a lower member (61) placed on a heat sink and an upper frame member (62) holding the LED module with its light source unit (1002) exposed through the frame opening. The upper member supported by the lower member via a hinge can open/close, and includes a pressing unit pressing the LED module set in the open state, against the lower member (61). The lower member (61) includes, in its main part, a lock unit (63) directly or indirectly lock the upper member (62) when the upper member is closed.

Various implements are known in the art, but fail to address the problem solved by the invention described herein. One embodiment of this invention is illustrated in the accompanying drawings and will be described in more detail herein below.

### SUMMARY OF THE INVENTION

The present invention discloses an integrated electronic light source module that has a base plate to support an electronic light source; a power supply to drive this light source; and a heat sink to dissipate the heat generated by this invention. The cooling fins of the heat sink are in perpendicular relation to the natural flow of heat generated. The base plate preferably has openings at and near the heat sink fins location providing a path of air flow through to the fins of the heat sink. Such a setup provides for effective heat dissipation and a more rapid cooling rate than disclosed in the prior art. Although the present invention can be completely autonomous, an optional coupling element can be included that is adapted to connect to an external power source, such as the socket of a light fixture. The coupling element can be removable and interchangeable with other coupling elements designed to suit a variety of applications. In turn, a number of different coupling elements can be produced and delivered in concert with an embodiment of the present invention. The electronic light source embodies the use of an LED element.

It is an object of the present invention to provide an electronic light source.

It is another object of the present invention to provide a practical, simple, and portable electronic device capable of producing light.

Yet another object of the present invention is to provide an electronic module which is simple and cost effective to mass produce market and adapt to existing uses.

Still another object of the present invention is to provide an electronic device having a low electromagnetic interference or EMI.

Yet another object of the present invention is to produce a device having a light source, a heat sink and a power supply, all in one unit.

It is still another object of the present invention to produce a device that can be easily adapted for use in a wide variety of implementations.

Another object of the present invention is to provide an electronic light source with efficient and fast heat dissipation.

Another object of the present invention is to provide easy replacement, trouble shooting and recycling components and material.

### BRIEF DESCRIPTION OF THE DRAWINGS

FIG. 1 shows the top view of the preferred embodiment of the present invention having a base plate with air holes, a heat sink located near the air holes and a power supply. Cool air flows from below of the base plate through the air holes and pushes the heated air created from the LED upward away from the heat sink and fins.

FIG. 2 shows a side view of the preferred embodiment of the present invention. Shown are the heat sink with cooling fins near air holes so that cooler air from air holes helps to remove heated air generated from the heat sink and fins, and a light source with an optional light diffusing lens.

FIG. 3 shows a side view of the preferred embodiment of the present invention. Shown are the base plate with air holes, the heat sink, the power supply and the light source with lens.

FIG. 4 is a side view of an alternative embodiment of the present invention, demonstrating the coupling element as a socket adapter which can be replaced with other coupling element for connection to external power source.

FIG. 5 is a top view of another alternative embodiment of the present invention, showing a rounded base plate with air holes right below the heat sink and fins for more effective heat removal.

FIG. 6 is a side view of yet another alternative embodiment of the present invention, demonstrating a different heat sink configuration at top of air holes on the base plate.

FIG. 7 is a top view of still another alternative embodiment of the present invention, demonstrating an optional positioning of the cooling fins at top of air holes on the base plate.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

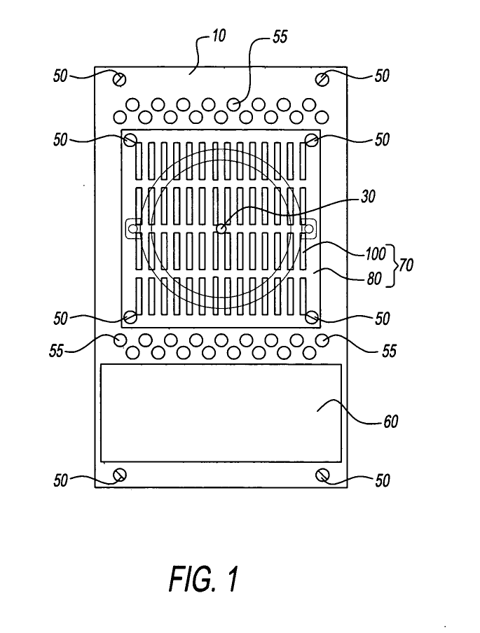

FIG. 1 discloses a bottom view of the preferred embodiment of the present invention. Shown are a base plate 10, a light source socket 30, fasteners 50, openings 55, a power supply 60, a heat sink 70, a heat sink plate 80, and comb-like cooling fins 100. Note that the cooling fins 90 may be fashioned into any shape that will not interfere with the heat dissipation process. In the preferred embodiment, the base plate 10 is a flat plate that provides support for the other components of the present invention and supplies the primary structural integrity to a completed module embodied in the present invention. As a result, it needs to be manufactured from a rigid and durable material such as, but not limited to, metal or hard polymer. The thickness of the base plate 10 varies in direct proportion to the size of the components used and with the intended use of the present invention. The preferred size of the base plate 10 is preferably between 3 and 12inches long, between 3 and 12 inches wide or 2 inches to 12 inches diameter, and between 1/16 and 3/16 inches thick. Alternatively the base plate 10 requirement may be circumvented by mounting all of the components of the present invention onto heat sink plate 80.

Still referring to FIG. 1, the fasteners 50 provide a strong bond between the various components of the present invention. The fasteners 50 may all be of the same diameter and length throughout this invention, or be of various sizes. Alternative bonding means can also be used, such as, but not limited to, soldering, welding or through the use adhesives. The openings 55 are created in a way whereby the base plate 10 is pierced completely through, thus creating an unobstructed flow of air from the side having the electronic light source 20 to the side having the cooling fins 90.

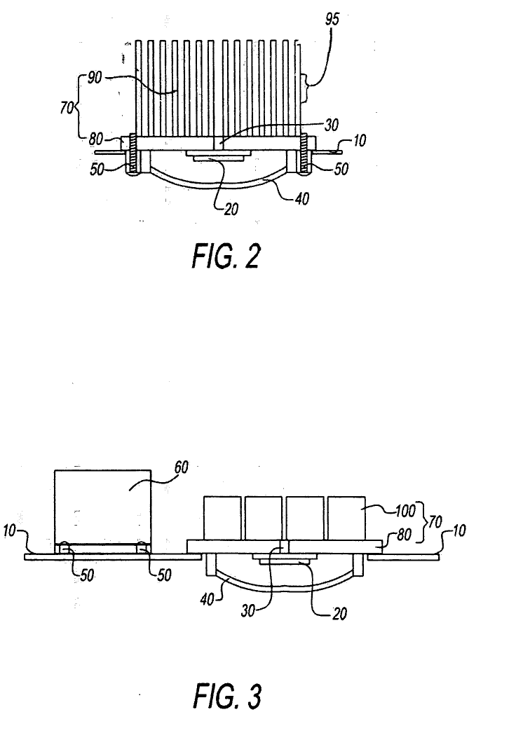

The power supply 60 is preferably an adapter for alternating current. An adapter is required because an LED light source requires a steady current flow to ensure proper operation and long life of the LED elements. A direct current adapter, although not standard, can still be used in an alternative embodiment. A different power supply will be required depending on the type of lighting used for the electronic light source 20 (FIG. 2). For example, in a fluorescent arrangement, a ballast will be employed for the power supply 60 to control the amount of current going through the electronic light source 20. Another alternative would be to utilize a battery pack for the power supply 60, such as in completely autonomous embodiments of the present invention.

FIG. 2 is a side view of the preferred embodiment of the present invention. Shown are a base plate 10, an electronic light source 20, a light source socket 30, a diffusion lens 40, fasteners 50, a heat sink 70, a heat sink plate 80, and cooling fins 90. The electronic light source 20 is pictured as a single unit LED element that is rated at one watts or higher. Alternatively, the electronic light source 20 may be disposed on the invention as a geometric combination, or in any formation involving several light sources installed on a single unit of the present invention. An LED light source, or a more advanced Organic LED light source, is the preferred embodiment for the electronic light source 20 over the standard incandescent or fluorescent lighting. The preference is mainly due to the many advantages of LEDs, including lower energy consumption, longer lifetime, improved robustness, smaller size and faster switching. Alternatively, standard incandescent and even fluorescent lighting may also be used. However, these embodiments are not preferred since they would increase the size of the device, reduce its life span and decrease efficiency. The preferred dimensions of the electronic light source 20, if used as an LED module, are between one half of an inch to three inches in diameter or in any other shape to that effect. The light source socket 30 is of a type commensurate with the type of electronic light source 20.

The diffusion lens 40 covers the electronic light source 20, and is attached to the heat sink plate 80 or the base plate 10 by means of fasteners 50. It can also be glued on, or snapped on, or utilize any other mounting means that may or may not be permanent. The diffusion lens 40 is not essential to enablement of the present invention. However, if present, it should preferably be either a diffusion lens 40 as shown, or a non-diffusion lens. While both types of lenses would protect the electronic light source 20 from scratching or other damage, only the diffusion lens 40 permits scattering of light over a broader area to promote a more uniform light propagation and distribution.

The heat sink 70 absorbs and dissipates the thermal heat generated by the electronic light source 20. The most common design of a heat sink 70 is a metal device with a series of cooling fins 90 that are emanating from the heat sink plate 80. Preferably, the heat sink 80 is made out of metal due to its high thermal conductivity. However, any other material capable of rapid heat absorption and dissipation may also be used. The cooling process is effectuated by transferring the thermal energy that is created as a byproduct of the current flowing though the electronic light source 20, to the surrounding cooler material, and eventually to the surrounding air mass.

In the present invention, the heat sink achieves a more rapid rate of cooling than in prior art due to the perpendicular orientation, preferably a ninety degree angle, of the cooling fins 90 when measured with respect to the heat sink plate 80 or the base plate 10. As used herein, the term “perpendicular orientation” can mean from 45° to 90°, as measured from the head sink plate 80 or base plate 10, more preferably 75° to 90°, most preferably 85° to 90°. This improvement prolongs the exposure of the spreading thermal energy to surface-to-air interaction by forcing it to flow along the wide side 95 of the cooling fins 90. This optimization decreases if the cooling fins 90 are positioned at a degree that is greater or lesser than perpendicular to the orientation of the natural flow of heat generated by electronic light source 20.

Referring to FIG. 3 shown are a base plate 10, an electronic light source 20, a light source socket 30, a diffusion lens 40, fasteners 50, a power supply 60, a heat sink 70, a heat sink plate 80, and comb-like cooling fins 100. Notice that the power supply 60 is mounted to the base plate 10 with fasteners 50. Alternatively, an adhesive, soldering, or welding, or any other means of secure, heat resistant attachment can be employed. The heat sink 70 is shown in FIG. 3 with a plurality of comb-like cooling fins 100, rather than broad, continuous cooling fins 90 shown in FIG. 2.

Still referring to FIG. 3, special notice should be paid to the distance separating the electronic light source 20 and the location of the power supply 60 on the base plate 10. The close proximity of the power supply 60 and the electronic light source 20 reduces EMI noise by shortening the distance that electric current traverse between components of this invention. The preferred proximity of the power supply 60 to the electronic light source 20 is between 1 and 6 inches.

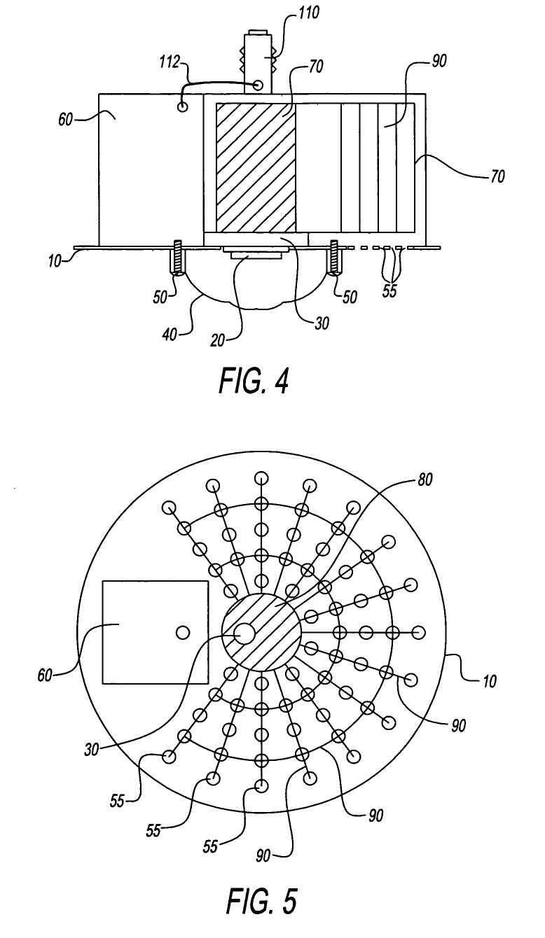

FIG. 4 teaches an alternative embodiment of the present invention. Shown are a base plate 10, an electronic light source 20, a light source socket 30, a diffusion lens 40, fasteners 50, openings 55, a power supply 60, a heat sink 70, cooling fins 90, a coupling element 110, and external wiring 112. In this embodiment, all components are in closer proximity to each other than in embodiments disclosed in the other figures. The coupling element 110 is shown as a socket adapter that may or may not be removable. A removable coupling element 110, otherwise known as a variable socket adapter, is useful in circumstances where the coupling means used by an external power source (not shown) do not fit a coupling element 110 that is currently disposed on the present invention. Under such circumstances, the coupling element 110 would be removed and replaced with a more suitable version. The wiring 112 for such a coupling element 110 may be connected to a separate socket located on the power supply 60, or anywhere else on this present invention. Alternatively such wiring 112 may be integrated with the coupling element 110. The wiring in the latter configuration would transfer signals and power to the present invention through a direct wire to wire contact (not shown) between similar connectors that are integrated within a female socket (not shown) located on the intended external power source (not shown), and those integrated on the coupling element 110.

Still referring to FIG. 4, the coupling element 110 supplies electric current to the power supply 60. The coupling element 110 may be either a male connector that connects to a matching female connector located on the external power source (not shown), or a female connector on the coupling element 110 utilizing a male connector originating from an external power source (not shown). The preferred type of power is an electrical current that is centrally generated and distributed via power lines to the location where the present invention is being used. The embodiment of the coupling element 110 shown in FIG. 4 is of a threaded male coupling element 110 connecting to a similar female coupling element (not shown) located on the exterior command source (not shown). The pictured external power source (not shown) regulates the operation of the present invention by either enabling or disabling the flow of electrical current. Alternatively, the present invention can be regulated by, but not limited to, lessening or intensifying the flow of electric current, thereby causing the electronic light source 20 to brighten or to dim. The electrical current flows throughout the present invention by means of wiring (not shown) directly connected to the power supply 60, or through a series of male/female connectors located directly on the components of the present invention. Alternatively, the present invention may have more then one coupling element 110 and be able to connect to a similar specimen as the present invention, so as to create a chain or an array of light producing units. In an array like embodiment the outer units will be coupled to the exterior command source (not shown), whereas all middle units will be coupled to each other.

FIG. 5 is yet another alternative embodiment of the present invention. Shown are a base plate 10, a light source socket 30, openings 55, a power supply 60, a heat sink plate 80, and cooling fins 90. Notice the plurality of openings 55 that function as air holes. Any single opening 55 completely perforates the entire thickness of the base plate 10, thus allowing air to travel from an area below the base plate 10 to an area above the base plate 10. The cooling fins 60 are located on top of, across or within close proximity to, openings 55. As thermal energy naturally flows away from the electronic light source 20 (not shown) and through the heat sink plate 80 into the cooing fins 90, it encounters the cooler ambient air from an area below the base plate 10. At this point a significant amount of heat is transferred to the cooler ambient air, which then facilitate the heat dissipation process. In this embodiment, the present invention has a rounded base plate 10. Such an embodiment is more suitable in some applications, such as with use in conventional or standard light fixtures (not shown).

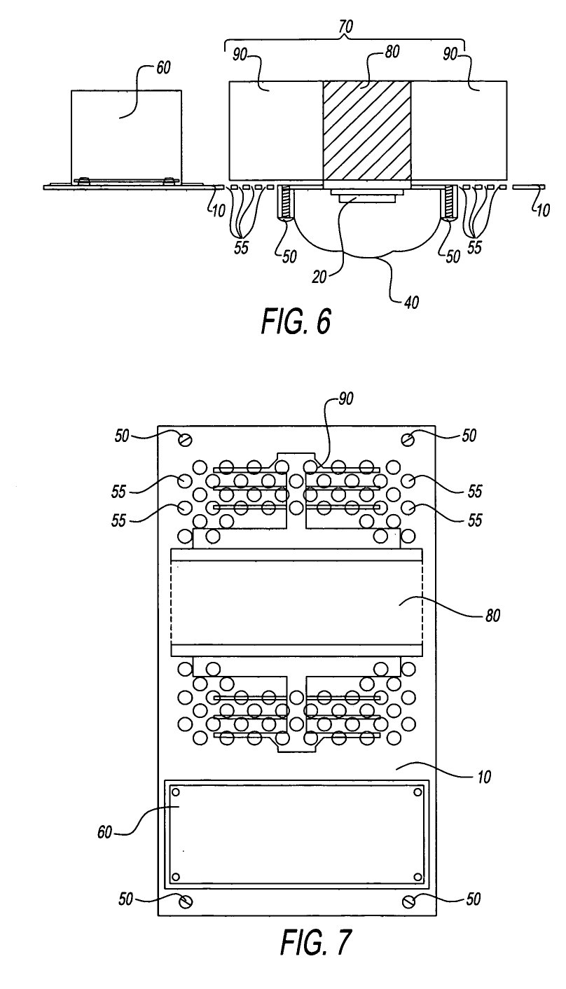

Additional embodiments of the present invention are shown in FIG. 6 and FIG. 7. The embodiment in FIG. 6 shows a base plate 10, an electronic light source 20, a light a diffusion lens 40, fasteners 50, openings 55, a power supply 60, a heat sink 70, a heat sink plate 80, and cooling fins 90. The cooling fins 90 are shown emanating from the heat sink plate 80. In this embodiment, heat generated by the light source flows from the heat sink 70 to the cooling fins 90 then dissipated from the cooling fins to ambient air. Cooler ambient air flows through the openings 55 from below the base plate 10, then upwards through the cooling fins 90. This configuration tends to be flatter but possibly laterally or longitudinally larger then the embodiments disclosed in prior figures. The embodiment of the diffusing lens 40 in FIG. 6 is substantially concave, rather then convex as in FIGS. 2 and 3. The diffusing lens 40 may additionally have impressed or etched curvatures of various sizes or types (not shown) on the exterior or interior surface of the diffusing lens 40. The present invention does not embody a preferable type of diffusing lens 40; rather the kind that is used will depend on the discretion of the user or on a specification of the use.

FIG. 7 shows an alternative embodiment for cooling fins 90. Also shown are a base plate 10, an electronic light source 20, a light source socket 30, a diffusion lens 40, fasteners 50, openings 55, a power supply 60, a heat sink 70, a heat sink plate 80, and cooling fins 90. The ultimate configuration and appearance of the present invention is dictated by the intended application as well as by the type of electronic light source 20 used in a particular embodiment. Diverse types of electronic light sources generate heat in different manner and with varying degrees of intensity. Both FIG. 6 and FIG. 7 are able to support a low profile fan (not shown) that would increase the rate at which the air flow would be channeled through the openings 55 and cooling fins 90. Such an embodiment would be preferable with especially intense light sources, or where air currents are insufficient, such as in closed or tight spaces.

Due to the highly portable nature of the present invention, it may be used as a standalone unit that generates light or be incorporated into a larger device. One wishing to use the present invention must supply power via the power supply 60, or provide batteries in an autonomous embodiment. Power then flows through an internal circuit to the electronic light source 20. Here the electromagnetic power is converted into luminous energy with thermal energy as byproduct. Separate cooling means, such as fans or ducts are unnecessary due to the presence of an effective heat sink, which draws the generated thermal energy away from the present invention, thus cooling the device. If the current device malfunctions or an upgrade is required, a replacement device embodied by the present invention is brought in as a replacement. The replaced unit can then be diagnosed and repaired as necessary or the replaced unit can be upgraded in a laboratory.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An integrated electronic light source module comprising;
a base plate;
an electronic light source is disposed on said base plate;
a power supply, wherein said power supply drives the electronic light source;
a heat sink having a plurality of cooling fins, wherein said heat sink is in thermal communication with said electronic light source, and,
wherein said cooling fins emanate from said heat sink in perpendicular orientation to the base plate.

2. The integrated electronic light source module of claim 1, further comprising a coupling element, wherein said coupling element is disposed on said structural base plate.

3. The integrated electronic light source module of claim 2, wherein said coupling element is a variable socket adapter.

4. The integrated electronic light source module of claim 1, wherein said electronic light source is an LED.

5. The integrated electronic light source module of claim 1, wherein said electronic light source is an array of LED.

6. The integrated electronic light source module of claim 1, wherein said cooling fins are comb-like cooling fins or other shape fins.

7. The integrated electronic light source module of claim 1, further comprising a light diffusion lens, and wherein said light diffusion lens covers said electronic light source.

8. The integrated electronic light source module of claim 1, wherein the exterior command source is a light fixture socket;

9. The integrated electronic light source module of claim 1, wherein the exterior command source is a power cable.

10. The integrated electronic light source module of claim 1, wherein said power supply is an alternating current adapter.

11. The integrated electronic light source module of claim 1, wherein said power supply is a direct current adapter.

12. The integrated electronic light source module of claim 1, further comprising a plurality of openings penetrating said base plate.

13. The integrated electronic light source module of claim 1, wherein said cooling finds are disposed very substantially near said plurality of openings.

14. The integrated electronic light source module of claim 12, wherein said cooling fins are disposed across said plurality of openings.

15. An integrated electronic light source module comprising;
an electronic light source;
a power supply, wherein said power supply drives the electronic light source;
a heat sink having a plurality of cooling fins, wherein said heat sink is in thermal communication with said electronic light source, and wherein said cooling fins emanate from said heat sink in perpendicular orientation to the base plate; and
wherein said light source and said power supply are disposed on said heat sink.

16. The integrated electronic light source module of claim 15, further comprising a coupling element, wherein said coupling element is disposed on said heat sink.

17. The integrated electronic light source module of claim 16, wherein said coupling element is a variable socket adapter.

18. The integrated electronic light source module of claim 15, wherein said electronic light source is an LED.

19. The integrated electronic light source module of claim 15, wherein said electronic light source is an array of LED.

20. The integrated electronic light source module of claim 15, further comprising a light diffusion lens, and wherein said light diffusion lens covers said electronic light source.
